(19) United States
(12) Patent Application Publication
(10) Pub. No.: US 2004/0262927 A1
(43) Pub. Date: Dec. 30, 2004

(54) Door lock device

(75) Inventors: Katsutoshi Fukunaga, Chiryu-shi (JP); Makoto Suzumura, Chita-shi (JP); Shigehiro Oya, Toyoake-shi (JP); Akira Muramatsu, Chiryu-shi (JP); Yukinobu Kunimatsu, Nishikamo-gun (JP); Takashi Nishio, Chita-shi (JP); Shigeru Tanabe, Obu-shi (JP)

Correspondence Address: BURNS DOANE SWECKER & MATHIS L L P, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 10/767,271

(22) Filed: Jan. 30, 2004

(30) Foreign Application Priority Data
Jan. 30, 2003 (JP) 2003-022298
Jan. 28, 2004 (JP) 2004-020004

(51) Int. Cl. E05C 3/06

(52) U.S. Cl. 292/216

(57) ABSTRACT

A door lock device includes a latch mechanism engageable with or disengageable from a striker, an open unit transmitting an opening operation force to the latch mechanism for disengaging the latch mechanism from the engagement with the striker, a lock unit transmitting locking and unlocking operation forces to the open unit for operating the open unit between an unlocking condition where the opening operation force is transmittable to the latch mechanism and a locking condition where the opening operation force is not transmittable to the latch mechanism, an actuator for outputting the locking and unlocking operation forces. The door lock device further includes a housing for storing the latch mechanism, the open unit, the lock unit and the actuator as a unit, and a case provided within the housing for accommodating at least the actuator.

### CROSS REFERENCE TO RELATED APPLICATIONS

The present application is based on and claims priority under 35 U.S.C § 119 with respect to Japanese Patent Application No. 2003-22298 filed on Jan. 30, 2003 the entire content of which is incorporated herein by reference.

### FIELD OF THE INVENTION

The present invention is generally directed to a door lock device and more particularly a door lock device for a vehicle door.

### BACKGROUND OF THE INVENTION

As a conventional door lock device, a Japanese Patent Application published as 2002-081246 discloses a door lock device for a vehicle. The door lock device disclosed therein includes a door lock main body with a lever movable between two positions and an actuator attached to the door lock main body. The actuator having an output member operates the lever to be movable between the two positions by a drive means, such as for example, a motor disposed within a housing. The door lock device disclosed in the publication has a feature that a cover member for covering the lever-attaching surface of the main body including the lever is integrally formed at the housing for accommodating the actuator fixed to the lock main body.

The drive means of the conventional door lock device described above is housed in the housing and a cover closes the housing. The assembling or combining of the housing and the cover is carried out by mere surface contact of both members (housing and cover). Accordingly, if any gap or clearance between the housing and the cover exits, water may invade into the interior from such gap to expose the drive means to the water.

A need thus exists for a door lock device has been developed to satisfy the needs noted above and improved a waterproof of the actuator of the door lock device.

### SUMMARY OF THE INVENTION

In light of the foregoing, the present invention provides a door lock device includes a latch mechanism engageable with or disengageable from a striker, an open unit transmitting an opening operation force to the latch mechanism for disengaging the latch mechanism from the engagement with the striker, a lock unit transmitting locking and unlocking operation forces to the open unit for operating the open unit between an unlocking condition where the opening operation force is transmittable to the latch mechanism and a locking condition where the opening operation force is not transmittable to the latch mechanism, an actuator for outputting the locking and unlocking operation forces. The door lock device further includes a housing for storing the latch mechanism, the open unit, the lock unit and the actuator as a unit, and a case provided within the housing for accommodating at least the actuator therein.

According to the feature of the invention above, since the actuator is accommodated within the case in the housing of the door lock device, the actuator is covered by a plurality of members (housing and casing) to prevent water from entering into the actuator even if the door lock device should be exposed to the water.

According to another aspect of the invention, a door lock device includes a latch mechanism engageable with or disengageable from a striker, an open unit transmitting an opening operation force to the latch mechanism for disengaging the latch mechanism from the engagement with the striker, a lock unit transmitting locking and unlocking operation forces to the open unit for operating the open unit between an unlocking condition where the opening operation force is transmittable to the latch mechanism and a locking condition where the opening operation force is not transmittable to the latch mechanism, an actuator for outputting the locking and unlocking operation forces and a housing for storing the latch mechanism, the open unit, the lock unit and the actuator as a unit. The housing includes a first housing half having a first wall and a second housing half. The door lock device further includes a second wall projecting from the first wall so as to be enclosing the actuator and a cap portion covering the actuator by assembling the first wall of the first housing half.

According to the aspect of the invention above, since the actuator is covered by the first wall, the second wall and the cap portion within the housing, the actuator becomes more waterproofed even if the door lock device should expose to the water.

### BRIEF DESCRIPTION OF THE DRAWINGS

The above and other objects, features and advantages of the present invention will be more apparent and more readily appreciated from the following detailed description of preferred exemplary embodiments of the present invention, taken in connection with the accompanying drawings, in which;

FIG. 1 is a partial view of a latch mechanism of the door lock device according to the first embodiment of the present invention;

FIG. 2 is a view showing back side of the door lock device of FIG. 1;

FIG. 3 is a partial view of lock mechanism and motor according to another embodiment of the invention;

FIG. 4 is a partial view similar to FIG. 3, but removing the cover from the door lock device;

FIG. 5 is a partial view similar to FIG. 4, but removing the cap portion from the door lock device;

FIG. 6 is a cross sectional view taken along the line A-A of FIG. 3;

FIG. 7 is a cross sectional view taken along the line B-B of FIG. 4;

FIG. 8 shows the door lock device of FIG. 1 under unlock state;

FIG. 9 shows the door lock device of FIG. 8 under the outside opening operation;

FIG. 10 shows the door lock device of FIG. 8 under the inside opening operation;

FIG. 11 shows the door lock device of FIG. 8 showing that the door lock device is changed to locking condition;

FIG. 12 shows the door lock device of FIG. 11 under the outside opening operation;

FIG. 13 shows the door lock device of FIG. 11 under the inside opening operation;

FIG. 14 shows the door lock device of FIG. 13 under further inside opening operation continued;

FIG. 15 shows the door lock device of FIG. 12 changed to unlock condition;

FIG. 16 shows the door lock device of FIG. 15 further changed to unlock condition continued;

FIG. 17 shows the door lock device according to the second embodiment under locked condition and inside opening operation;

FIG. 18 shows the door lock device of FIG. 17 under further inside opening operation; and

FIG. 19 shows a cross-sectional view of the door lock device with a housing and a case according to the third embodiment of the invention.

### DETAILED DESCRIPTION OF THE PRESENT INVENTION

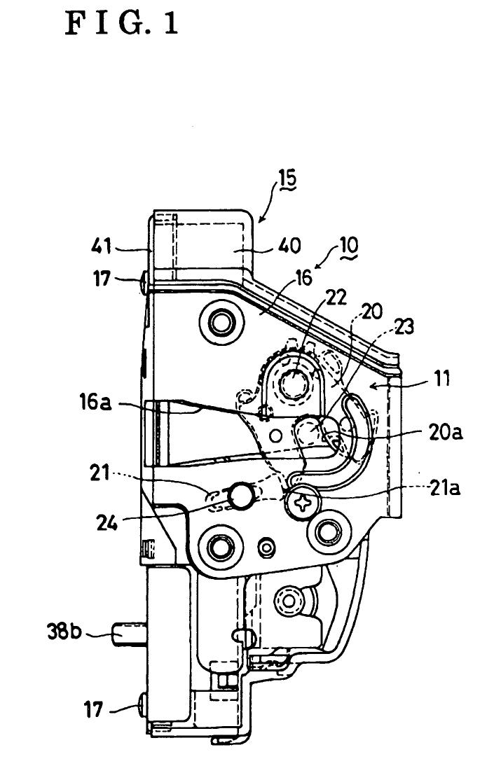

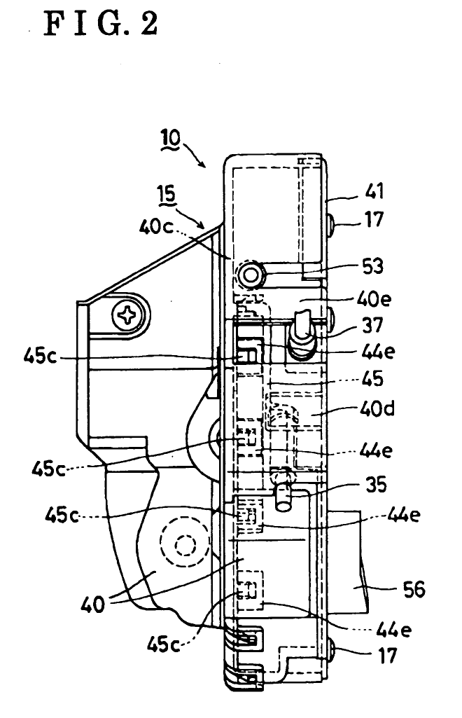

A door lock device 10 according to the first embodiment generally includes a latch mechanism 11, open unit 12, lock unit 13 and motor 14 (actuator). These components are housed integrally in a housing 15. The latch mechanism 11 is arranged within a first plane surface extending in parallel with the paper space of FIG. 1 and a lock mechanism formed by the open unit 12 and the lock unit 13 and the motor 14 are arranged within a second plane extending in vertical with the first plane (vertical to the paper space). The housing 15 includes a housing half 40 (first housing half) covering the lock mechanism and the motor 14 portions in the right direction as viewed in FIG. 2 and further covering the latch mechanism 111 integrally in inward direction of the paper space in FIG. 2 and a cover 41 (second housing half) covering the lock mechanism and motor 14 portion and assembled with the first housing half 40 at the outer peripheral portion. The housing half 40 (first housing half) is made of resin while the cover 41 (second housing half) is made of metal according to this embodiment. However, it should be noted that the material used for the housing is not limited to this embodiment. The shapes of the housing halves 40 and 41 are not limited to these shown in the embodiment.

The latch mechanism 11 is explained with reference to FIG. 1. The latch mechanism 11 includes a latch 20 and a pawl 21. The latch 20 is rotatably supported by a latch shaft 22 and is provided with an engaging groove 20a. The groove 20a can engage with and hold a striker 23 fixed to a vehicle body (not shown) inside of the latch 20. The pawl 21 is rotatably supported by a pawl shaft 24 and is provided with an engaging portion 21a. The engaging portion 21a engages with the latch to restrict the latch from rotating in clockwise direction as viewed in FIG. 1.

Now explaining the operation of the latch mechanism 11, FIG. 1 shows the latched condition that the door is closed relative to the vehicle body. Under such latched condition, the latch 20 engages with the striker 23. When the pawl 21 is rotated from this condition in clockwise direction to a certain amount (angle) centering the pawl shaft 24, the engaging portion 21a of the pawl is disengaged from the latch 20. Then the latch 20 is rotated by a spring (not shown) in clockwise direction. The engaging groove 20a is aligned with a recess 16a formed on a base member 16. Under such condition, the striker 23 can be moved away from the engaging groove 20a in the left direction as viewed in FIG. 1, The door becomes unlatched to be opened relative to the vehicle body. This means that the latch 20 is released from the striker 23.

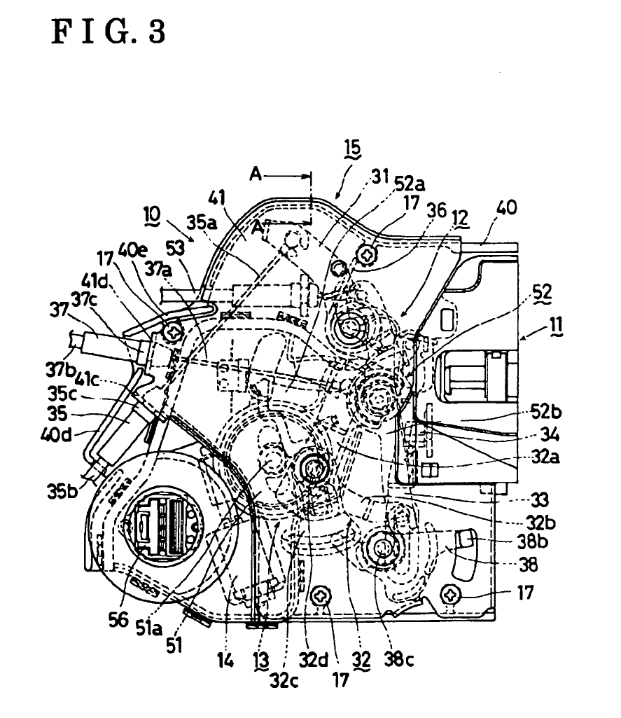

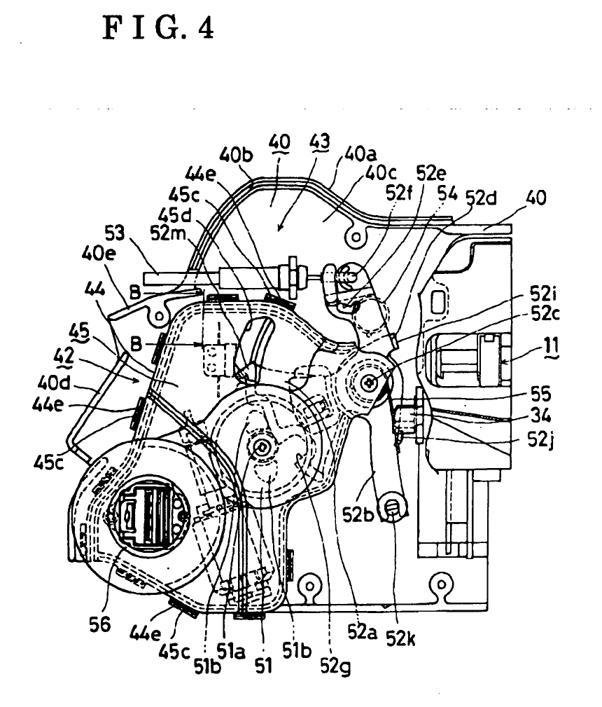

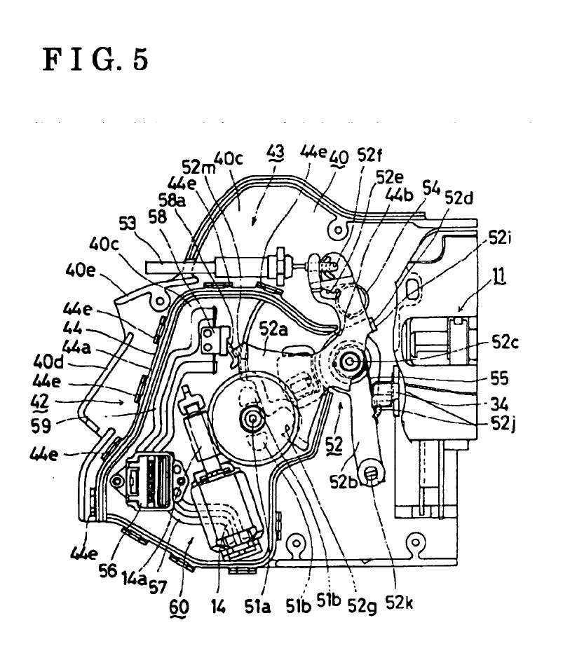

The inside of the housing 15 will be explained with reference to FIGS. 1 to 8. FIGS. 3 to 5 shows the door lock shown in the left side of FIG. 1. FIG. 4 shows the condition that the cover 41 has been removed from the door lock device and FIG. 5 shows the condition that cap portion 45 (second case half) has been further removed from the door lock device of FIG. 4.

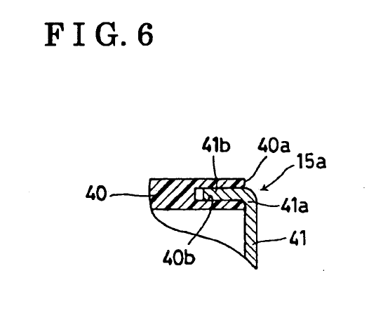

Explaining first about the housing 15 structure, as shown in FIG. 3, the housing half 40 and the cover 41 are fixed through four pins 17. The fixing method is not limited to this method. As particularly shown in FIG. 6, the housing 40 is formed with a groove 40b along an upper brim 40a concaved in the left direction as viewed in FIG. 6. The cover 41 is formed with a flange portion 41b along an upper brim 41a projecting toward the left direction as viewed in FIG. 6. The groove 40b and flange portion 41b are engaged with each other when the housing half 40 and the cover 41 are assembled. Compared with the surface contact of the conventional structure, since this structure will not allow water or external objects to be introduced at the assembling portion 15a. The assembling portion 1 Sa formed by the groove 40a and flange portion 41b is formed at the upper side of the housing and accordingly, even when the water is introduced from the upper side of the door lock device 10, the water will not invade into the housing 15. However, such assembling portion 1 Sb can be formed along the entire periphery of the housing half 40 and cover 41 or may be formed at a part of the periphery other than the upper side.

As shown in FIG. 4 and FIG. 5, a case 42 is provided in the housing 15 and formed integrally therewith. The case 42 is formed such that a space 43 is provided within the housing between the upper side and right side as viewed in FIG. 4 or 5. The upper side means the vehicle upper side when the door lock device 10 is assembled in the door of the vehicle. In this embodiment, the case 42 and the housing 15 are aligned at the lower portion, but the case 42 may be provided at the position where the space is provided at the lower side of the housing 15.

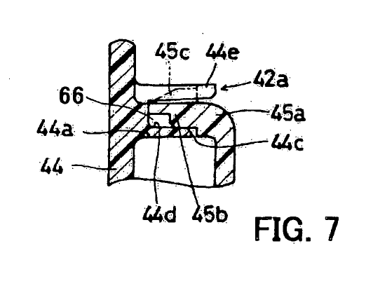

Now explaining about the structure of the case 42, the case 42 includes a case half 44 (first case half) and a cap portion 45 (second case half). Both cap portion 45 and the case half 44 are assembled to form the case 42. The case half 44 includes a reference wall 40c (first wall) commonly with the housing half 40 and is provided with a wall 44a (second wall) projecting from the reference wall 40c (first wall) toward the front direction of the paper space of FIG. 5. The wall 44a is of peripheral shape and has a recess 44b. As shown detail in FIG. 7, the case half 44 is formed with a groove 44d (second groove) concaved in the left direction as viewed in FIG. 7.

On the other hand, the cap portion 45 is provided with a projection 45b (second projection) projecting along the brim 45a in the left direction as viewed in FIG. 7. The projection 45b is engaged with the groove 44d when the cap portion 45 and the case half 44 are assembled. A water drain channel 66, which is communicated with the outside, is formed outside of the housing 15. In order to come water or external objects into the case, water or external objects have to get over the projection 45 and also not to discharge from the housing 15 through the drain channel 66. Compared with the structure where the both brims 44c and 45a are in surface contact, the structure of the embodiment will not allow water or external objects to be introduced into the case 42 from the assembling portion 42a of the case 42. Engagement portion between the groove 44d and the projection 45b is provided at the upper side of the case and therefore, the water will not be introduced into the case 42 even if the door lock device 10 is exposed to the water from the upper side. However, such assembling portion 42a can be formed along the entire periphery of the case half 44 and the cap portion 45, or may be formed at a part of the periphery other than the upper side.

The assembling of the case half 44 and the cap portion 45 is made through a plurality of detent portions 44e formed on the case half 44 engage with a plurality of pawl portions 45c formed on the cap portion 45.

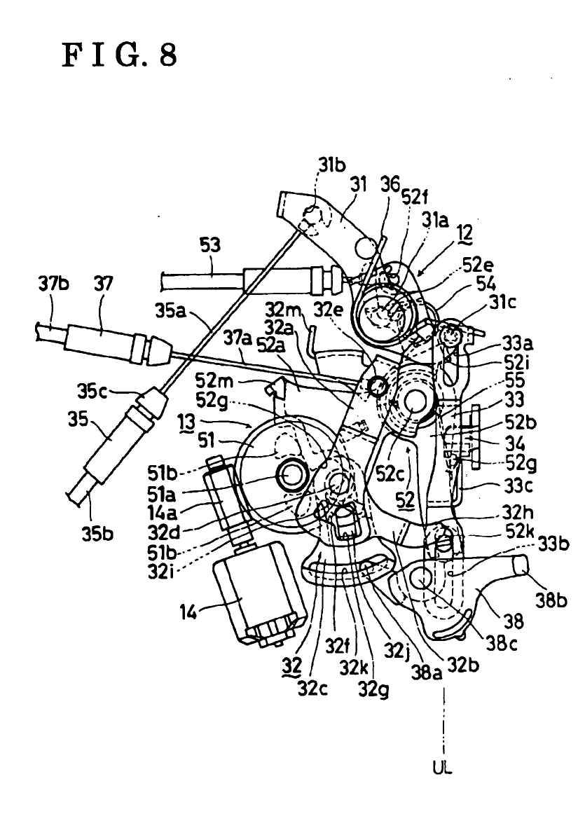

Next explaining about the structure of the lock mechanism and motor 14 in the housing, in FIG. 8, these components only are illustrated for explanatory purpose and particularly in FIG. 3, the numerals of the part of the components are omitted to simplify the explanation. The lock mechanism includes the open unit 12 and the lock unit 13. The open unit 12 transmits the operation force to the latch mechanism 11 from an outside handle (not shown) provided outside of the vehicle door and an inside handle (not shown) provided inside of the vehicle door (compartment side) thereby to operate the latch mechanism to be released from the engagement with the striker 23. The lock unit 13 transmits the locking or unlocking operation force by a locking knob (not shown) which is provided inside of door at the compartment side or the motor 14, etc. to the open unit 12 thereby to allow the open unit to be under unlock condition (door unlock condition) or lock condition (door locked condition). The unlock condition means that the open unit 12 can transmit the opening operation force to the latch mechanism 11 and the lock condition means that the open unit 12 cannot transmit the opening operation force to the latch mechanism 11.

The open unit 12 includes an outside open lever 31, an inside open lever 32, an open link 33 and lift lever 34.

The outside open lever 31 is rotatably supported by the cover 41 centering the pin 31a within the housing 15 and is provided with a connection recess 31b at one end and a connecting shaft 31c at the other end. The connection recess 31b is connected to a cable 35, which is operatively connected to the outside handle.

The cable 35 includes an inner cable 35a one end of which is connected to the outside handle side and the other end of which is connected to the connection recess 31b and an outer casing 35b which covers the inner cable 35a. As shown in FIG. 3, an end portion 35c of the outer casing 35b is fixed to a fixed flange portion 41c of the cover 41. As shown in FIGS. 2 and 3, the housing half 40 includes an umbrella portion 40d (protection portion) covering the end portion 35c from the upper side. Accordingly, the end portion 35c will not be exposed to the water and prevents invasion of the water into the gap formed between the inner cable 35a and the outer casing 35b.

When the outside handle is operated, the outside open lever 31 is rotated about a pin 31a in counter clockwise direction as viewed in FIG. 8. The connecting shaft 31c then moves upward in FIG. 8. A spring 36 is engaged with the connecting shaft 31c.

The inside open lever 32 includes a first inside open lever 32a, a second inside open lever 32b and an intermediate lever 32c. These levers are supported by the cover 41 within the housing 15 and rotatable about a pin 32d relative to the cover 41. The first inside open lever 32a is formed with a connecting hole 32e at one end and an irregular shape hole 32f at the other end. The first inside open lever 32a also includes a cancel flange 32m at the left side relative to the connecting hole 32e. The connecting hole 32e is connected to a cable 37 associated with the inside handle.

The cable 37 includes an inner cable 37a connected to the inside handle side at one end and connected to the connecting hole 32e at the other end and an outer casing 37b which covers the inner cable 37a. As shown in FIG. 3, an end 37c of the outer casing 37b is fixed to the fixed flange portion 41d of the cover 41, The housing half 40 includes an umbrella portion 40e (protection portion) covering the end portion 37c from the upper side. Accordingly, the end portion 37c will not be exposed to the water and prevents invasion of the water into the gap formed between the inner cable 35a and the outer casing 37b.

The second inside lever 32b is provided with an elongated hole 32g and an engaging end portion 32h. Further, the intermediate lever 32c is provided with an elongated hole 32i, engaging projection 32j and an arc-shape hole 32k. The engaging projection 32j is inserted through the elongated hole 32g of the second inside lever 32b and the irregular shape hole 32f of the inside lever 32a. A connecting shaft 38a of a child protector lever 38 is inserted into the arc-shape hole 32k. The child protector lever 38 is rotatably supported by the cover 41. When the child protector lever 38 is rotated about a pin 38c by the operation of an operating portion 38b, the intermediate lever 32c moves in vertical direction as viewed in FIG. 8. Upon movement of the intermediate lever 32c the engaging projection 32j relatively moves within the elongated hole 32g and irregular shape hole 32f relative and the pin 32d relatively moves within the elongated hole 32i.

When the intermediate lever 32c positions at the position shown in FIG. 8, i.e., when the child protector is not set, the entire inside open lever 32 rotates in counter clockwise direction as viewed in FIG. 8 about the pin 32d. On the other hand, when the intermediate lever 32 moves upward in FIG. 8 and the engaging projection 32j positions at the upper end of the elongated hole 32g (when the child protector is set), the first inside open lever 32a is rotated based on the operation of the inside handle, but the engaging projection 32j merely moves within the irregular shape hole 32f. In other words, under this condition, the intermediate lever 32c and the second inside open lever 32 are not rotated.

The open link 33 is provided with connecting elongated holes 33a and 33b at both ends, respectively and a flange 33c of approximately L shape in cross section. The upper side connecting elongated hole 33a is connected to the connecting shaft 31c of the outside open lever 31.

The lock unit 13 of the lock mechanism includes a wheel gear 51 and active lever 52. The wheel gear 51 is of circular shape and is supported by the rotating shaft 51a and rotatable relative to the cap portion 45. The wheel gear 51 is housed in the case 42 provided in the housing 15. The wheel gear 51 is provided with gear teeth at the outer periphery thereof and is formed at the position eccentric to the rotating shaft 51a so that the projection 51b projects inward of the paper space. The projection 51b rotates around the rotating shaft 51a when the wheel gear 51 rotates.

The active lever 52 includes a resin made lever 52a and metal lever 52b. These levers are rotatably supported by the cap portion 45 centering the rotation axis 52c (screw). The active lever 52 positions one part within the case 42 via a recess portion 44b and position the other part outside of the case 42 within the housing 15.

The resin made lever 52a includes a recess 52g, pressing portion 52d (FIG. 5), an irregular shape hole 52e, a connecting hole 52f and an engaging portion 52m. The recess 52g is engaged with the projection 51b when the wheel gear 51 is rotated. The connecting hole 52f of the resin made lever 52a is connected to a cable 53 associated with a lock knob (not shown) provided inside of the compartment. In the irregular shape hole 52e a positioning spring 54 is provided and is engaged with the hole 52e at one end and engaged with a reference wall 44a at the other end. The engaging portion 52m projects frontward and extends outside of the case 42 from the inside via an elongated hole 45d formed on the cap portion 45.

On the other hand, the metal lever 52b includes flanges 52i and 52j and boss 52k. As shown in FIG. 5, the pressing portion 52d of the resin made lever 52a is in contact with the flange 52i. When the torque is applied on the resin made lever 52a to rotate in clockwise direction centering around the rotation center 52c, the pressing portion 52d presses upon the flange 52i so that the active lever 52 as a whole is rotatable. A spring 55 is provided between the resin made lever 52a and metal lever 52b. The spring 55 is engaged with the resin made lever 52a at one end and wound around the rotation center 52c. The spring 55 is engaged with the flange 52j of the metal lever 52b at the other end. When the torque is applied on the resin made lever 52a to rotate around the rotation center 52c in counter clockwise direction, the active lever 52 as a whole becomes rotatable by the biasing force of the spring 55.

The boss 52k of the metal lever 52b is connected to the connecting elongated hole 33b of the open link 33.

The motor 14 is fixed to the reference wall 40c within the case 42 as shown in FIG. 5. As shown in FIG. 5, the motor 14 is connected to a connector 56 fixed to the reference wall 40c within the case via bus bar 57 (electric supply route). As shown in FIG. 3, the connector 56 can be connected from outside of the housing 15. The motor 14 is driven by CPU (not shown) arranged outside of the door lock device 10. The motor 14 includes output shaft and worm gear 14a provided on the output shaft. The worm gear 14a meshes with the wheel gear 51 and rotatable in both directions by motor 14. The motor 14 directly operates the wheel gear 51. The wheel gear 51 operates the active gear 52 to change the state of the door lock device 10 to locking state from unlocking state or unlocking to locking state. In other words, the motor 14 outputs the locking/unlocking operation force of the door lock device.

As shown in FIG. 5, the reference wall 40c within the case 42 is fixed to a position switch 58 (detecting member). The position switch 58 includes a switch piece 58a engageable with the resin made lever 52a of the active lever 52 and detects rotation position of the active lever 52. The rotation position of the active lever 52 determines the locking or unlocking state of the door lock device 10. The position switch 58 functions to detect the locking or unlocking state of the door lock device 10. As shown in FIG. 5, the position switch 58 is connected to the connector 56 via a bus bar 59 (signal route). The state of the door lock device 10 detected by the switch 58 is transmitted to the CPU outside of the door lock device 10 via the connector 56.

The electric parts such as motor 14, connector 56, position switch 58 and bus bars 57 and 59 are housed in the case 42 within the housing 15. The case 42 is structured to have a gap or clearance 43 at least at upper side of the housing 15. Accordingly, plurality of members such as the housing 15 and the case 42 cover the electric parts such as motor 14 viewing from upper side of the door lock device 10. Thus, the door lock device 10, particularly the case 42 has good waterproof characteristic.

Now explaining about the door lock operation with reference to FIGS. 8 to 16 in which only the main parts necessary for explaining the operation such as the open unit 12, the lock unit 13 and the motor 14 are illustrated: (Unlock condition opening operation)

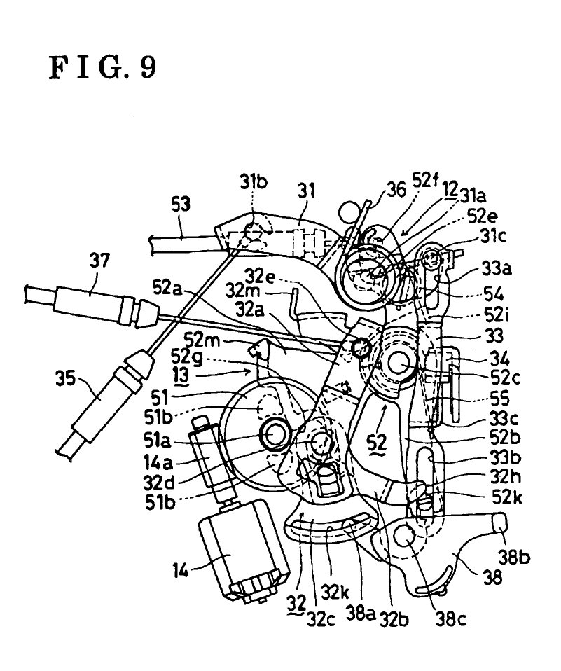

FIG. 8 shows the door lock device positioning in unlock condition where the active lever 52 as a whole and the open link 33 are positioned at unlock position (UL). When the outside open lever 31 is rotated in counter clockwise direction centering about the pin 31a based on the operation of the outside handle, the open link 33 moves upward and the flange 33c of the open link 33 engages with the lift lever 34 to move the lever upward. This lift lever 34 is rotatably supported by the pawl shaft 24 for unitary rotation therewith. When the lift lever moves upward, the pawl 21 is rotated in clockwise direction to have the latch mechanism 11 change from latched condition to unlatched condition. FIG. 9 shows the condition after the above operation has been completed.

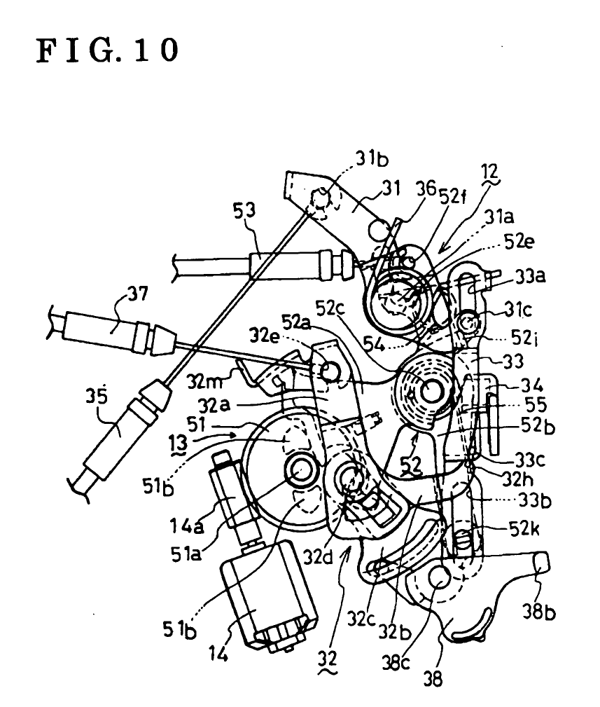

Under the unlock condition shown in FIG. 8, when the inside open lever 32 as a whole is rotated in counter clockwise direction centering the pin 32d based on the operation of the inside handle, the engaging end portion 32h of the second inside open lever 32b engages with the flange 33c to move the open link 33 upward. Similar to the outside door handle operation, the flange 33c of the open link 33 engages with the lift lever 34 to move the lever upward. The latch mechanism 11 then changes the condition from latched to unlatched condition. FIG. 10 shows the condition after the above operation has been completed.

(Lock/Unlock Operation)

Under the unlock condition of FIG. 8, when the motor 14 is actuated, the wheel gear 51 is rotated in counter clockwise direction to engage the projection 51b with the recess 52g. When the resin made lever 52a is rotated in clockwise direction about the rotation center 52c, the pressing portion 52d presses the flange 52i to rotate the active lever 52 as a whole. Then the open link 33 moves from the unlock position to the lock position by rotating in clockwise direction by a certain angle about the connecting shaft 31c due to the connection structure between the boss 52k of the metal lever 52b and the connecting elongated hole 33b of the open link 33. The door lock device 10 is positioned at the lock position (L).

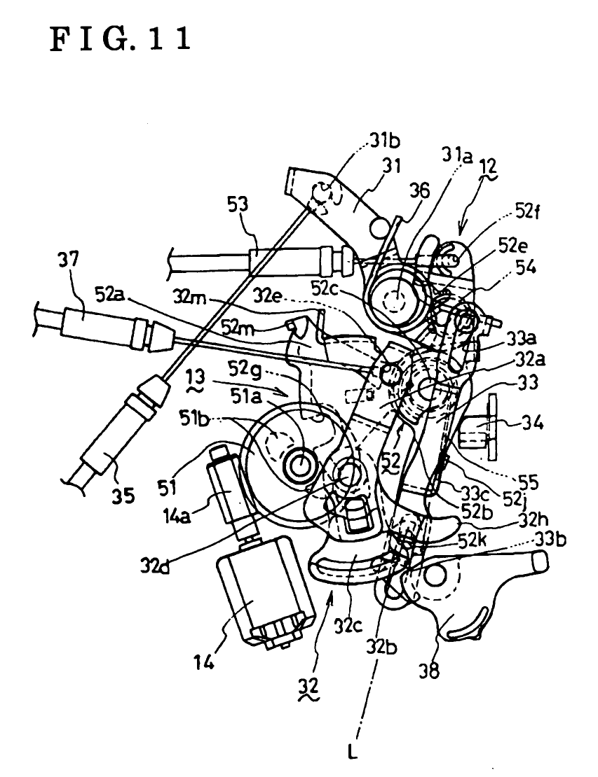

FIG. 11 indicates the lock position. The lock operation can be also achieved by, for example, the operation of the lock knob by rotation of the resin made lever 52a about the rotation center 52c via the cable 53.

As shown in FIG. 11, when the wheel gear 51 is rotated in clockwise direction by the actuation of the motor 14, the projection 51b of the wheel gear 51. engages with the recessed portion 52g of the resin made lever 52a to rotate the resin made lever in counter clockwise direction about the rotation center 52c. The active lever as a whole then rotates by the biasing force of the spring 55. Then the open link 33 moves from the lock position to the unlock position due to the connection structure between the boss 52k of the metal lever 52b and the connecting elongated hole 33b of the open link 33. The door lock device 10 is positioned at the unlock position (UL) shown in FIG. 8. This operation can be also achieved by operating the lock knob. The spring force of the spring 55 selectively determines the unlock and lock positions of the active lever 52 and the open link 33.

(Lock Condition Outside Open Operation)

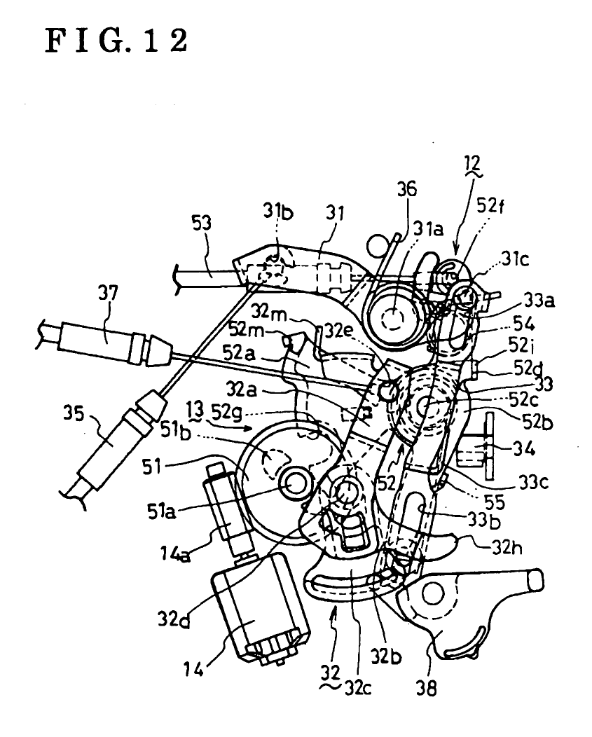

As shown in FIG. 11, when the outside handle is operated, the outside open lever 31 is rotated in counter clockwise direction to move the open link 33 upward. The flange 33c movement locus by the movement of the open link 33 is offset from the lift lever 34. In other words, the flange 33c merely moves without engaging with the lift lever. Accordingly, even when the outside open lever 31 is rotated, the latch mechanism 11 maintains its latched position. This operation is illustrated in FIG. 12. If the outside handle is returned to the position from the condition shown in FIG. 12, the outside open lever 31 is rotated in counter clockwise direction to return to the position of FIG. 11.

(Lock Condition Inside Open Operation)

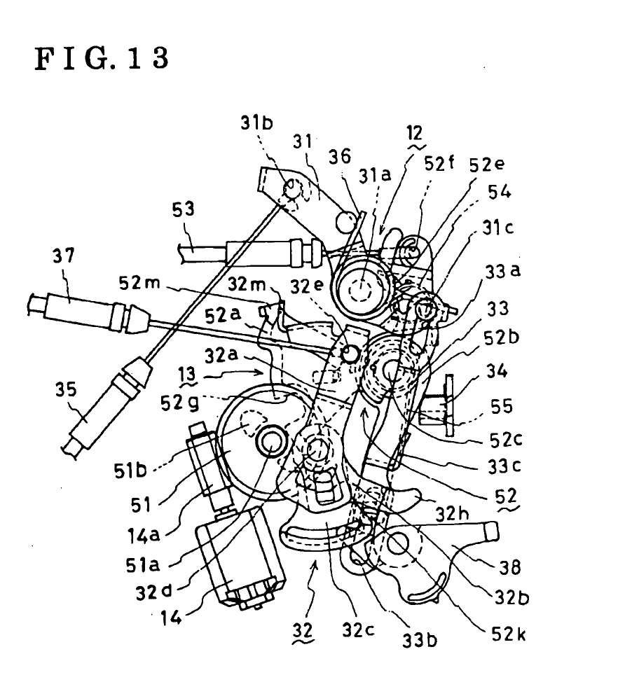

From the lock condition shown in FIG. 11, when the inside handle as a whole is operated, the canceling flange t32m of the first inside open lever 32a engages with and presses the engaging portion 52m of the resin made lever 52a of the active lever 52 toward the lower left side. Since the engaging portion 52m extends outward of the case 42 via the elongated hole 45d of the cap portion 45, the canceling flange 32m can engage with the engaging portion 52m. FIG. 13 shows the condition after the above operation has been completed.

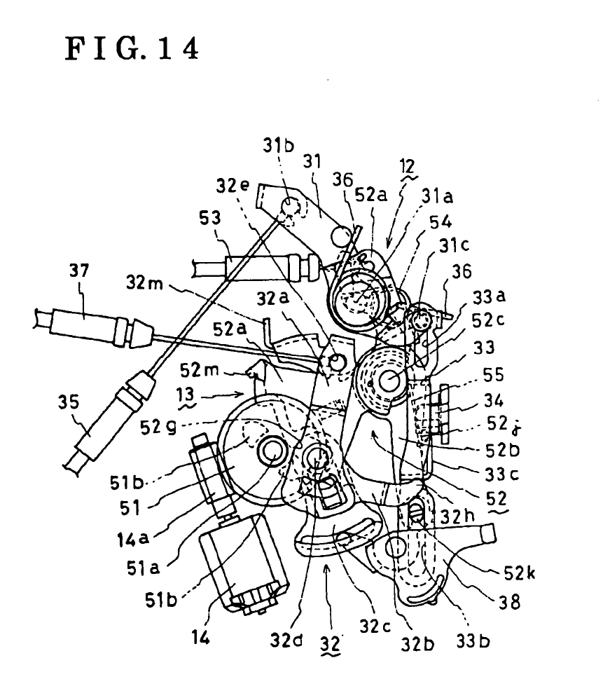

From the condition shown in FIG. 13, when the inside open lever 32 as a whole is further rotated in counter clockwise direction, the resin made lever 52a also moves to rotate the active lever 52 as a whole in counter clockwise direction about the rotation center 52c to move the active lever 52 and the open link 33 to the unlock position. FIG. 14 shows the condition after the above operation has been completed.

The engaging end portion 32h of the second inside open lever 32b is upwardly engageable with the flange 33c under the condition of FIG. 14. When the inside open lever 32 is further rotated in counter clockwise direction about the pin 32d, the open link 33 moves upward to operate the latch mechanism 11 to unlatched position from the latched position.

According to the embodiment of the invention, even under the lock condition, the switching to the unlock condition and opening operation by one operation of the inside handle (one motion function)

(Unlock Operation After Lock Condition Open Operation)

The operation will be explained hereinafter the case when the switching operation to the unlock condition by the operation of outside handle or by motor 14 from the lock condition shown in FIG. 11 is made repeatedly (this repeated operation may be made when the door system includes a so-called smart entry system). The smart entry system is a system wherein under the user of the vehicle (key owner) detected to be near own vehicle, when the user approaches the outside handle, the sensor such as electro-static capacitance sensor detects the needs of opening the door, the CPU drives the motor 14 to unlock the door lock device. In this case immediately before the switching to the unlock condition by the motor 14, the user may operate the outside handle.

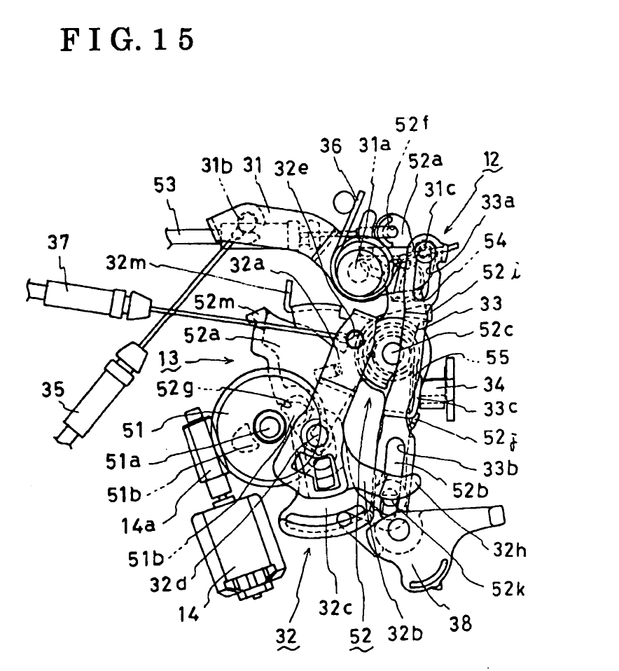

When the outside handle is operated from the condition shown in FIG. 11, the condition is changed to the condition shown in FIG. 12. From this condition, if the wheel gear 51 is rotated in clockwise direction by the actuation of the motor 14, the active lever 52 as a whole and the open link 33 are moved to the unlock position. The flange 33c of the open link 33 then engages with the lift lever 34. FIG. 15 shows the condition after the above operation has been completed.

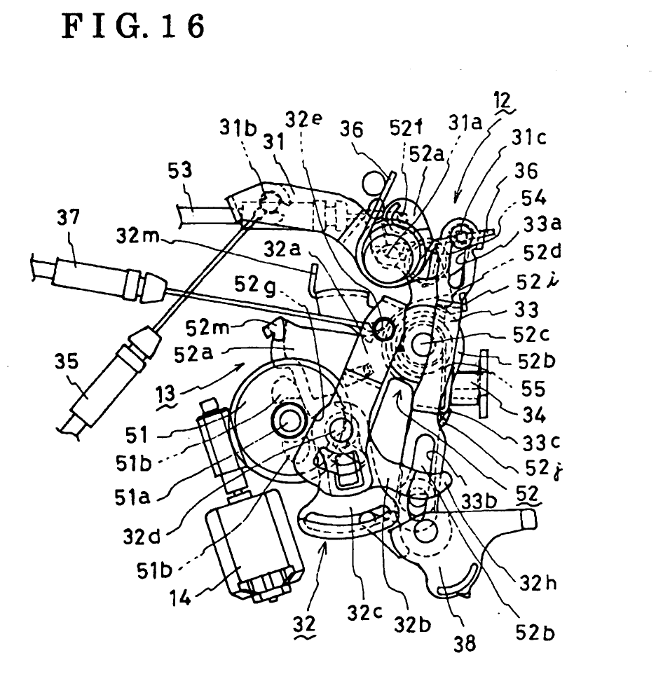

Under this condition, further movement of the link 33 to the right is restricted by the engagement of the flange 33c with the lift lever 34. The resin made lever 52a moves relative to the metal lever 52b against the biasing force of the spring 55. In other words, the resin made lever 52a further rotates in counter clockwise direction, but rotation of the open link 33 and the metal lever 52a connected to the open link is restricted by the lift lever 34. FIG. 16 shows the condition after the above operation has been completed.

From the condition shown in FIG. 16, when the outside handle is released to its original position, the open link 33 moves downward as viewed in FIG. 16. The flange 33c and the lift lever 34 are released from the engagement. The metal lever 52b and the open link 33 move to the unlock position by the force of spring to return to the unlock condition shown in FIG. 8.

As explained, even if the open operation and the switching operation to the unlock condition from the lock condition are repeatedly made by the outside handle, the condition is changed to the unlock condition by returning the outside handle to its original position. Accordingly, the latch mechanism can be operated to the unlatched position.

(Second embodiment)

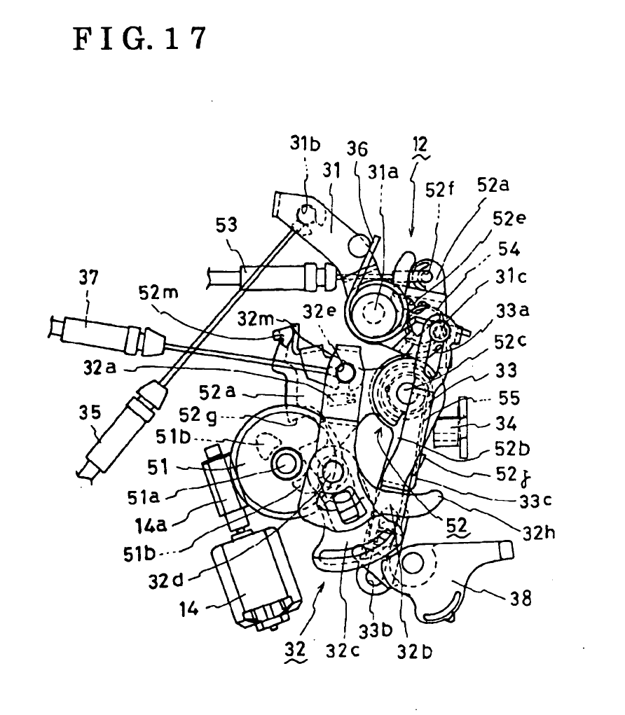

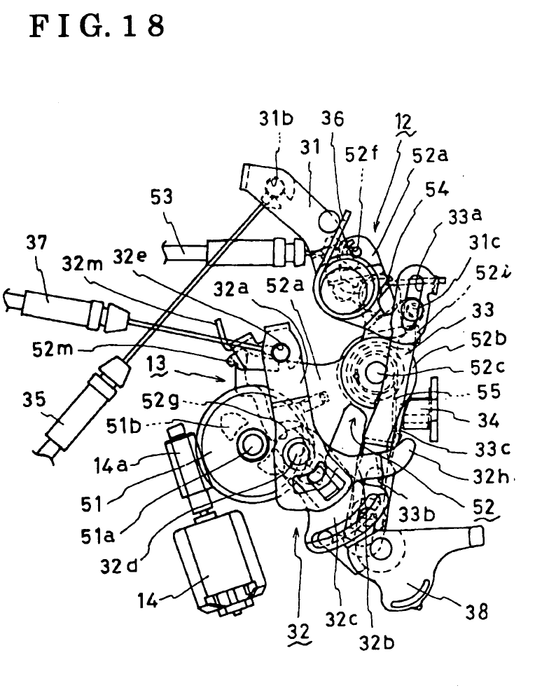

FIGS. 17 and 18 show the second embodiment of the invention. The difference between the previous embodiment and the second embodiment is a difference in shape of the first inside open lever 32a of the inside open lever 32. In other words, the distance from the connecting hole 32e to the canceling flange 32m is shorter in the second embodiment than that of the previous embodiment.

(Lock Condition Inside Open Operation)

According to the second embodiment, when the inside handle is operated from the lock condition shown in FIG. 11, the inside open lever 32 as a whole is rotated in counter clockwise direction. The canceling flange 32m of the first inside open lever 32a engages with and presses downward the engaging portion 52m of the resin made lever 52a of the active lever 52. FIG. 17 shows the condition after the above operation has been completed.

According to a further rotation of the inside open lever 32 as a whole, the second inside open lever 32b engages with and presses upward the flange 33c of the open link 33 thereby to move the open link 33 upward. Since the distance between the connecting hole 32e and the canceling flange 32m is shorter in this embodiment, the movement of the open link 33 toward the unlock position is retarded compared to the case of the previous embodiment. As a result, the flange 33c of the open link 33 engages with the lift lever 34 in the right direction to restrict the movement of the open link 33 toward the right direction. However, the resin made lever 52a part of the active lever 52 is rotated in counter clockwise direction about the rotation center 52c against the biasing force of the spring 55. FIG. 18 shows the condition after the above operation has been completed.

When the inside handle is returned to the original position from the condition shown in FIG. 18, the open link 33 moves downward to release the engagement between the flange 33c and the lift lever 34. Then the metal lever 52b and the open link 33 move to the unlock position by the biasing force of the spring 55 to be in the unlock condition corresponding to the condition shown in FIG. 8. When the inside handle is again operated, normal opening operation can be achieved to operate the latch mechanism 11 from latched condition to the unlatched condition.

According to the second embodiment, even under the locked condition, by operating the inside handle twice, the switching operation to the unlock condition and opening operation can be achieved to function as a two motion operation.

According to the invention of both embodiments, one motion function can be changed to two motion function by minor change of shape of the inside open lever 32.

The reference wall 40c is commonly used for the case half 44 and the housing half 40 according to the embodiments. However, such wall can be formed separately for both case half and housing half.

(Third Embodiment)

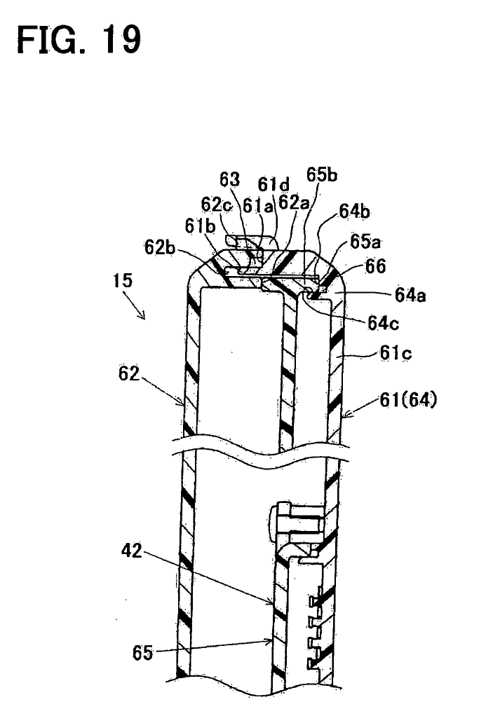

The third embodiment will be explained base on the FIG. 19. The third embodiment having a different structure on the housing 15 and case 42 comparing with the first embodiment.

The housing 15 includes a resin made housing half 61 and a resin made cover 62. A flange portion 61b is formed along with a verge 61a of the housing half 61. On the other hand, a groove 62b is formed on the housing half 61 along with a verge 62a of the cover 62. When the cover 62 and the housing half 61 is assembled, the flange portion 61b and the groove 62b fitted together and a drain channel 63 is formed between the verge 61 of the housing 61 and the verge 62b of the cover 62.

The case 42 includes a resin made case half 64 and a resin made cap portion 65. The case half 64 is sharing a reference wall 61c of the housing half 61 and having a wall 64a which is projecting from the reference wall 61c. A groove 64c is formed along with a verge 64b of a wall 64a which is formed on the case half 64. On the other hand, a projection portion 65b is formed along with a verge 65a of the cap portion 65. When the cap portion 65 and the case half 64 is assembled, the projection portion 65b and the groove 64c fitted together and a drain channel 66 is formed between the verge 64b of the wall 64a and the verge 65a of the cap portion 65. A plurality of locking part 61d are formed on the housing half 61. A plurality of engaging part 62c are formed on the cover 62. The housing half 61 and cover 62 are fastened through the locking part 61d and the engaging part 62c. The case half 64 and the cap portion 65 are fastened by clipping the cap portion 65 which is positioned between the verge 64b of the wall 64a and the verge 65a of the cap portion 65.

In order for introducing water into the housing 15 through a fitting surface which is formed between the housing half 61 and the cover 62, water has to override the flange portion 61b without discharging from the housing 15 through the drain channel 63. According to the third embodiment, an entering of water into the housing 15 is relatively restricted comparing with the first embodiment. Should water come into the housing 15, water has to override the projection portion 65b without discharging from the housing through the drain channel 66. Consequently, an entering of water into the case 42 is relatively restricted as well as the first embodiment. In this third embodiment, the more entering or intrusion of water into the housing 15 is restricted, the more entering or intrusion of water into the case 42 is restricted comparing with the first embodiment.

According to an aspect of the invention, since the actuator is covered by the first wall, the second wall and the cap portion within the housing, the actuator becomes more waterproofed even if the door lock device should expose to the water.

According to a feature of the door lock device, since the separate two halves of the housing are assembled to each other by engagement of the recess and projection, the assembling portion can more securely prevent water from entering into the housing compared to the structure of surface contact engagement in the conventional device.

According to another feature of the door lock device of this invention, since the separate two halves of the case are assembled to each other by engagement of the recess and projection, the assembling portion can more securely prevent water from entering into the case compared to the structure of surface contact engagement in the conventional device.

According to another feature of the invention, the housing and the case has a first common wall integrally formed to reduce the number of parts and simplify the structure compared to the structure having separate walls of the housing and the case.

What is claimed is:

1. A door lock device comprising:
a latch mechanism engageable with or disengageable from a striker;
an open unit transmitting an opening operation force to the latch mechanism for disengaging the latch mechanism from the engagement with the striker;
a lock unit transmitting locking and unlocking operation forces to the open unit for operating the open unit between an unlocking condition where the opening operation force is transmittable to the latch mechanism and a locking condition where the opening operation force is not transmittable to the latch mechanism;
an actuator for outputting the locking and unlocking operation forces; and
a housing for storing the latch mechanism, the open unit, the lock unit and the actuator as a unit, wherein
the housing includes a case for storing at least the actuator therein.

2. A door lock device according to claim 1, wherein the housing includes a first housing half and a second housing half;
one or the other of the first or second housing half having a first recessed portion;
other one or the other of the first or second housing half having a first projection portion for engaging with the first recessed portion when one of the housing half is assembled to another housing half.

3. A door lock device according to claim 1, wherein the case includes a first case half and a second case half;
one or the other of the first or second case having a second recessed portion;
other one or the other of the first or second case having a second projection portion for engaging with the second recessed portion when one of the case half is assembled to another case half.

4. A door lock device according to claim 1, wherein the opening operation force is inputted to the open unit via a cable having an inner cable connected to the open unit and an outer casing fixed to the housing at an end portion and covering the inner cable and wherein the housing includes a protection portion for covering the end portion.

5. A door lock device according to claim 1, further comprising:
a first common wall provided on the housing and the case.

6. A door lock device comprising:
a latch mechanism engageable with or disengageable from a striker;
an open unit transmitting an opening operation force to the latch mechanism for disengaging the latch mechanism from the engagement with the striker;
a lock unit transmitting locking and unlocking operation forces to the open unit for operating the open unit between an unlocking condition where the opening operation force is transmittable to the latch mechanism and a locking condition where the opening operation force is not transmittable to the latch mechanism;
an actuator for outputting the locking and unlocking operation forces; and
a housing for storing the latch mechanism, the open unit, the lock unit and the actuator as a unit, the housing includes a first housing half having a first wall and a second housing half
a second wall projecting from the first wall so as to be enclosing the actuator and
a cap portion covering the actuator by assembling the first wall of the first housing half.

7. A door lock device according to claim 6, further comprising:
an electric supply route provided on the first wall of the first housing half and connected to the actuator.

8. A door lock device according to claim 7, further comprising:
a connector provided at the first wall and connected to the electric supply route and extends penetrating through the cap portion.

9. A door lock device according to claim 8, further comprising:
a detecting member provided at the first wall for detecting the locking and unlocking conditions and a signal route provided at the first wall and connected to the detecting member and the connector.
